(19) United States
(12) Patent Application Publication
(10) Pub. No.: US 2024/0283541 A1
(43) Pub. Date: Aug. 22, 2024

(54) Free-Space Optical Communications Link Using Direct Laser Modulation

(71) Applicants: Richard Joseph Tansey, Reno, NV (US); Bhaskar Durvasula, Los Altos, CA (US); Kathy A. Shockey, Los Gatos, CA (US)

(72) Inventors: Richard Joseph Tansey, Reno, NV (US); Bhaskar Durvasula, Los Altos, CA (US); Kathy A. Shockey, Los Gatos, CA (US)

(21) Appl. No.: 18/171,588

(22) Filed: Feb. 20, 2023

(51) Int. Cl. H04B 10/50; H04B 10/11; H04B 10/29; H04J 14/02

(52) U.S. Cl. CPC H04B 10/504; H04B 10/11; H04B 10/29; H04J 14/0205

(57) ABSTRACT

A system and method for providing high-capacity point-to-point free-space optical communications employing direct laser modulation and wavelength division multiplexing to minimize hardware complexity, cost, size, weight and power. The architecture supports data capacities in the 100-200 gigabits per second class between multiple terminals and relays situated on land, mobile vehicles, persons, ships, airborne high-altitude platforms or drones, and orbiting spacecraft.

### CROSS-REFERENCE TO RELATED APPLICATIONS

This application claims priority from a U.S. Provisional Patent Application Ser. No. 63/382,365, filed on Nov. 4, 2022, which is incorporated herein by reference in its entirety.

### FIELD OF THE INVENTION

This invention relates to high-capacity free-space optical communications links, and more particularly to a system and method for the provision of such links through direct laser modulation and combining many single-frequency channels in the optical signal transmission.

### BACKGROUND OF THE INVENTION

The telecommunications industry has been hesitant to adopt free-space optical links for satellite services or terrestrial services. This is in large part due to complexity and cost of devices and device implementations for high-order modulation of digital data streams onto laser light. These devices have significant, inherent non-linearities and inefficiencies that can only be dealt with through complex implementations.

The prevailing optical modulation approaches can be divided into direct and external modulation. Direct laser modulation (DLM) inserts the modulation at the point of laser light generation by varying laser current in accordance with the modulating analog or digital data stream. External laser modulation (ELM) imposes the modulation on previously generated, constant-power, continuous wave (CW) laser emission.

Direct modulation has the disadvantage of limited frequency response, relaxation oscillation, and chirp due to the dynamics of charge carrier generation in currently available laser diodes that limits the modulating signal frequency to approximately 10 GHz although some recent devices are rated at 15-20 GHz. These characteristics also render higher-order modulation techniques such as Phase Shift Keying (PSK) and Quadrature Amplitude Modulation (QAM) unsuitable for use in DLM; thus, Amplitude Modulation (AM), Frequency Modulation (FM), and On-Off Keying (OOK) are the preferred practical lower-order techniques. As a result, a single DLM beam has limited data carrying capacity but is simple and cost-effective to implement. Multiple beams combined can achieve higher aggregate data capacity.

External laser modulation requires the use of Mach-Zehnder Modulator (MZM) or Electro Absorption Modulators (EAM) which can employ higher-order modulation techniques but at the cost of significant complexity, cost, and size, weight and power (SWAP) in proportion to the targeted signal bandwidth, due to the increasing circuitry replication and the need to mitigate the inherent non-linearities and inefficiencies of these devices. These non-linearities and inefficiencies degrade important characteristics such as average vs peak power, min/max amplitude excursions, polarization, frequency chirp, and general beam train losses which must all be controlled to achieve the desired data capacity. Thus, ELM has greater data carrying capacity per individual beam but is quite complex and costly to implement.

The complexity associated with the dominant ELM technology, the MZM, can be tolerated in fixed, environmentally-controlled, and continually monitored and maintained infrastructure applications where size, power efficiency, and weight are not dominant issues. MZM applications typically need a range of complex supporting equipment including tight control of temperature and pressure conditions or via feedback loops to compensate for variations in those conditions. In addition, more feedback loops and control is typically needed to provide sufficient linearity and bias control. Additional feedback loops are required to support non-periodic digital modulation and analog modulation waveforms. These complexities and constraints represent almost prohibitive disadvantages in mobile and portable applications and in airborne or space vehicles, for which space, weight, and power are at a premium.

The fact that the degrading effects of modulation can be better controlled, or are inherently controlled, in the gain medium using DLM than in an already generated beam using ELM devices has led investigators to propose various DLM implementations to improve data capacity. This generally takes the form of wavelength division multiplexing of several single-frequency DLM beams. For example, U.S. Pat. No. 7,440,655B2 describes an adaptation of an Arrayed Waveguide Grating (AWG) as a device which can perform Wavelength Division Multiplexing (WDM) on multiple single-frequency DLM beams to enhance system data capacity. The AWG when reversed in the light flow can also act as a demultiplexer. The device described in U.S. Pat. No. 7,440,655B2 uses a duplex AWG in the transmitting and receiving regions to overcome passband limitations when using a single AWG. For early AWG technology, this was a potentially beneficial but fairly complex method for ensuring sufficient wavelength separation between individual single-frequency beams.

U.S. Pat. No. 8,472,805 describes a method and device for WDM of multiple laser beams at different frequencies using tunable multi-wavelength transmitter modules. These modules incorporate external modulation techniques with the complexities referred to above, and do not contemplate DLM. Multiplexing is done with a variety of techniques including AWGs. This patent represents a common but very complex and expensive architecture for increasing communications capacity.

European Patent EP0654917B1 describes techniques for generating multiple wavelengths in a single laser, separating the individual wavelengths, and modulating these wavelengths using the conventional external modulation techniques. The approach appears to lead to a limitation of the number of single wavelengths that can be WDM multiplexed to 20 channels, primarily based on a concern over chromatic dispersion in optical fibers. This is claimed to be mitigated to a degree with a complex series of devices. This patent illustrates the system complexities involved in attempting to exploit a simplification in one component, as well as the challenges in minimizing channel interference in long fiber.

An example of using direct laser modulation in free-space optical communication is summarized in the paper “Compact Optical Transmitters for CubeSat Free-Space Optical Communications” by Kingsbury, Caplan and Cahoy, in Proc. SPIE 9354, Free-Space Laser Communication and Atmospheric Propagation XXVII p 93540S, 2015. In this case, the technology and architecture were selected to perform a very limited function under severe size, weight and power (SWAP) constraints. The authors did not contemplate how multiplexing many single wavelength channels could reach well beyond their target capabilities. Thus, their free-space laser link throughput (bandwidth) is no greater than 0.03% of that of the present invention.

### SUMMARY OF THE INVENTION

The present invention is based on exploiting, specifically for free-space optical communications, a new generation of highly stable laser technology along with a direct modulation strategy which overcomes the problems of the prior art while enabling high communications capacities using compact laser terminals for terrestrial (including stationary, mobile, portable and airborne) and space communications.

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is directed to a system and method for higher capacity free-space broadband optical networks and point-to-point links at a lower cost.

It is another object of the present invention to reduce the hardware extent and complexity of such networks and terminals supporting the point-to-point links.

It is still a further object of the present invention to efficiently and securely provide optical communications links involving one or more mobile, portable, transportable, and airborne and space-borne terminals that cannot be supported by optical fiber connections.

It is yet a further object of the present invention to efficiently and securely service emerging data-intensive applications for intelligence, surveillance, and reconnaissance as well as tactical operations.

The invention uses a combination of Distributed Feedback (DFB) lasers and Arrayed Waveguide Gratings (AWG) to exploit Direct Laser Modulation (DLM) for high-capacity free-space communications systems. The extreme frequency precision and stability of DFB lasers allows many individual laser beams to be wavelength-division-multiplexed (WDM) without interference within the frequency range assigned for optical communications. However, in fiber applications, there are limitations to the number of beams that can be successfully multiplexed as a function of transmission distance, as chromatic dispersion degrades individual frequency beamwidths to the point of beam interference and information degradation; a typical number of multiplexed beams may be 40 or fewer for short communications distances and substantially less for long distances. The present inventors realized that this limitation can be overcome by using free-space transmission wherein chromatic dispersion is not a factor. In this case, as many as 150 beams can be multiplexed within the optical communication bands. While typical AWGs may be designed for multiplexing 40 beams, multiple AWGs can be configured in parallel to WDM the larger numbers of beams. There are many envisioned laser communications applications wherein this method can be applied to achieve extremely high optical data rates through the atmosphere between moving platforms and fixed stations, between multiple moving platforms, and between fixed stations separated by challenging terrain. In addition, it can be applied in space communications systems for extremely high-capacity ground-to-space, space-to-space, and space-to-ground links.

Thus, the present inventors' insight is that the high stability of distributed feedback lasers, combined with direct laser modulation into multiple single wavelength beams, combining such beams to achieve very high data capacities, and transmitting the combined beam as free-space optical links whereby chromatic dispersion is eliminated so as to fully preserve the carried data, is enabling for terrestrial, airborne and satellite communication systems, including portable and mobile systems, that can produce extremely high data rates to users at a very low cost per bit-per-second (bps).

### BRIEF DESCRIPTION OF THE DRAWINGS

A clear understanding of the key features of the invention summarized above may be had by reference to the appended drawings, which illustrate the method and system of the invention by using an example case, although it will be understood that such drawings depict preferred embodiments of the invention and, therefore, are not to be considered as limiting in scope with regard to other embodiments which the invention is capable of contemplating. Accordingly:

FIG. 1 illustrates the block diagram outlining the direct laser modulation of radio frequency (RF) signals and the wavelength-division multiplexing (WDM) of a very large number of individual laser beams (frequencies) onto a single optical transmission beam.

FIG. 2 illustrates the block diagram outlining the reception of the single optical transmission beam, demultiplexing it into many single-frequency beams, and demodulation to recover the original RF signal content.

FIG. 3 illustrates the frequency allocation for the individual single-frequencies generated by an array of DFB lasers.

FIG. 4 illustrates the communication links in a predominantly terrestrial and airborne communication system environment.

FIG. 5 illustrates the communication links in an intelligence, surveillance and reconnaissance application and possible tactical communications environment.

FIG. 6 illustrates optical communications capabilities in a tactical environment utilizing mobile, transportable and portable optical terminals.

FIG. 7 illustrates the communication links in a space communications constellation system application with possible airborne relays.

FIG. 8 summarizes the applications in which the free-space optical architecture of the invention can be applied with benefits in terms of data capacity and security.

### DETAILED DESCRIPTION OF THE INVENTION

The subject matter will now be described more fully hereinafter. The subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

The following detailed description makes reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details. In other instances, well-known structures and apparatus are shown in block diagram form in order to facilitate describing the subject innovation.

The following detailed descriptions represent exemplary embodiments of the invention. Parameters may be modified to meet specific objectives of the implementation without departing from the essential scope of this invention. The following detailed description of the invention describes the free-space optical communication system architecture and the performance that it enables.

The invention employs the characteristics of Distributed Feedback (DFB) lasers, Direct Laser Modulation (DLM), and free-space transmission to synergistically enable cost-effective, high-capacity optical communications in free space applications. DLM is used to maintain significant hardware simplicity in encoding a digital or analog data stream by directly modulating the laser drive current, but is typically limited to modulation frequencies of 10 GHz and below. DFB lasers produce optical beams with highly precise and stable frequency, which allows a bank of DFB lasers to generate multiple individual single-frequency laser beams separated by suitable guard bands. These single-frequency beams then can be wavelength-division-multiplexed into a transmission beam. Transmitting this beam in a free-space environment eliminates the chromatic dispersion that, in fiber transmission, constrains the number of such multiple individual single-frequency laser beams that can be successfully transmitted over long distances. In a free space environment, the guard bands can thus be significantly reduced so that many more single frequencies can be accommodated in the available bandwidth for optical communications.

To directly encode data on a laser for optical communications, the electric drive current is varied to modulate the intensity of the light. This DLM approach is simple and is used in various fiber-optic systems, but the disadvantage of directly modulating a laser is that there are frequency shifts associated with the intensity variations, known as laser chirp. These frequency shifts cause the signal to degrade, limiting the bandwidth that can be successfully supported to typically no greater than 10 GHz.

In a DFB laser, the grating and the reflection generating the lasing effect is generally continuous along the cavity, making the laser more stable. Inducing a quarter-wave shift in the cavity creates a resonance in the center of the reflectivity bandwidth and the laser then lases at this resonance and is extremely stable, since the grating and the cavity shift together as the temperature and current may change. This stability is a key factor in facilitating the use of small guard bands when wavelength-division multiplexing many beams together.

An exemplary technique for wavelength division multiplexing of multiple single frequency laser beams is an Arrayed Waveguide Grating (AWG). AWGs are capable of multiplexing many wavelengths into a single optical beam at any transmission point of the optical communication network. An AWG consist of a number N input couplers for the N single-frequency beams to be multiplexed, a free space propagation section, a grating waveguide section containing N waveguides with a constant length increment, another free space propagation section, and an output coupler carrying the multiplexed beam. Light is coupled into the device via optical fibers connected to the N input ports. Each wavelength of light is focused via the propagation section to the appropriate grating waveguide, in which it undergoes a constant change of phase attributed to the constant waveguide length increment, and then is focused through the second propagation section into the output. An identical AWG operated in reverse is used as a demultiplexer to retrieve individual channels of different wavelengths at the receiving end of the optical communication link.

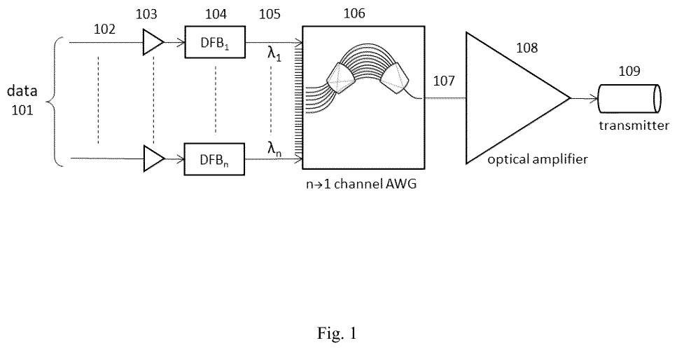

FIG. 1 illustrates the configuration block diagram of a transmission point of the optical network or link. Digital and/or analog data 101, managed for example by a Field-Programmable Gate Array (FPGA) or an Application-Specific Integrated Circuit (ASIC), is provided in a quantity “n” of channels 102 and individually amplified by electronic amplifiers 103. Each amplified channel is connected to DFB Laser 104 and is used there to modulate the input current, thereby modulating the laser beam intensity with the data signal. Each of the “n” DFB lasers is tuned to a unique wavelength. The resulting “n” single-wavelength optical beams 105 are combined into a single fiber 107 through Wavelength Division Multiplexing (WDM) by one or more AWGs 106. Typically, in view of readily available device technology in the 2022 timeframe, if the channel count “n” is 44 or fewer, a single AWG will suffice. If “n” is greater than 44, i.e., multiple laser communication bands are used, additional AWGs may be used with their output beams further combined into a single fiber. The aggregated optical signals in the fiber are amplified by an optical amplifier such as an Erbium Doped Fiber Amplifier (EDFA) 108. The resulting amplified beam is routed to an optical transmitter telescope 109 where the beam is launched into free space and steered via appropriate mechanisms and optics. For certain links, for example from a ground terminal to a high-altitude relay platform (HARP) or from a HARP to a Low Earth Orbit (LEO) satellite, the beam power per channel at the output of the AWG may be sufficient for link closure and thus an EDFA may not be required.

The number “n” may be selected based on the desired system communications capacity up to the number of individual laser beam wavelengths that can be accommodated within the optical communications bands at an appropriate wavelength separation. In one exemplary system, where a choice may be made to limit the system to the C band (1530 to 1565 nm) and with wavelengths separated conservatively by 0.8 nm, the number of channels “n” would be approximately 40. If the S, C and L bands were to be used at the same channel separation, the number of channels “n” could be as high as 150 and could even be greater with tighter separation. However, utilization of these bands would be prioritized based on device technologies, since not all devices are available, suitable or equally capable in all three bands. For example, currently available EDFA amplifier technology is only applicable for the C band and at lower gain levels for the L band; thus, when expansion of utilization to S band becomes desirable, appropriate and feasible device technologies are expected to be identified and developed as motivated by market demand.

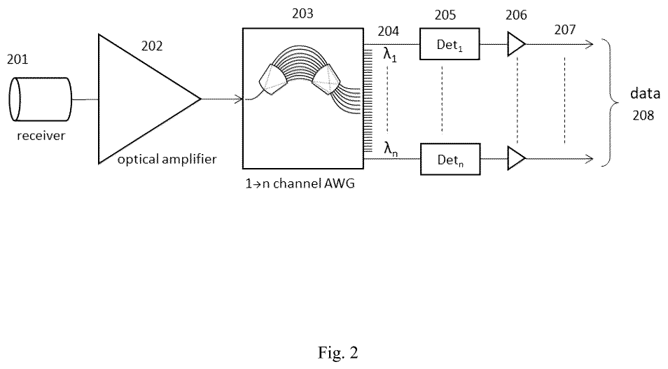

FIG. 2 illustrates the configuration block diagram of a receiving point of the optical network or link, where in large measure the process is the reverse of that described for transmission. Receiving telescope 201 captures the free space optical signal and inserts it into fiber. An EDFA 202 amplifies the optical signal, which subsequently is inserted into the single end of an AWG 203 where the beam is separated into the original “n” optical channel wavelengths 204. Signal detectors 205, such as PIN diodes, extract the electrical analog or digital signal from each of the optical beams 204. These resulting electrical signals are then processed by electronic amplifiers 206 to yield individual data channels 207, thereby reconstructing a replica 208 of the original data 101.

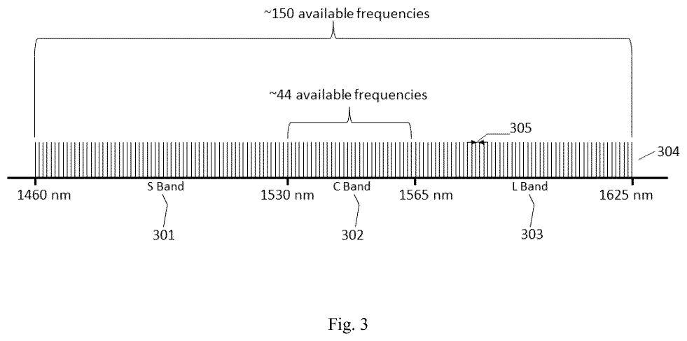

FIG. 3 illustrates the wavelength allocation for the individual single-frequency beams generated by an example array of DFB lasers. The available wavelengths for communications include the S band (1460-1530 nm) 301, C band (1530-1565 nm) 302, and L band (1565-1625 nm) 303. At a wavelength separation 305 of 0.8 nm, more than 150 individual frequencies 304 are available within these three bands. At a likely feasible separation of 0.4 nm, this would double to 300 individual frequencies. Initial applications are likely to focus on C band, enabling up to 44 channels at 0.8 nm separation or up to 88 at 0.4 nm separation.

The performance of this free space optical communications architecture may be illustrated for an initial application in C band using 32 single-frequency channels. With each single frequency being DLM modulated with data at 5 gigabits per second (Gbps), the data throughput is 160 Gbps from a single laser transmitting terminal with a very compact front end which can be readily accommodated on a satellite, an airborne ISR vehicle or airborne communications node (ACN), as well as stationary and even mobile ground assets including ships. Employing two light polarizations would further double that capacity by replicating the beam generation, modulation, multiplexing and amplification chain and combining the resulting beams with appropriate optics. This throughput can be appreciated by observing that 160 Gbps represents roughly 5,000 high-definition video channels streaming simultaneously. Thus, it is suitable for streaming, aggregating and/or relaying data from many sources as well as for remote operations. This architecture is vastly more efficient in size, weight and power (SWAP) than radio frequency systems providing only 1% of the data capacity. The following discussion describes examples of several classes of applications of this invention.

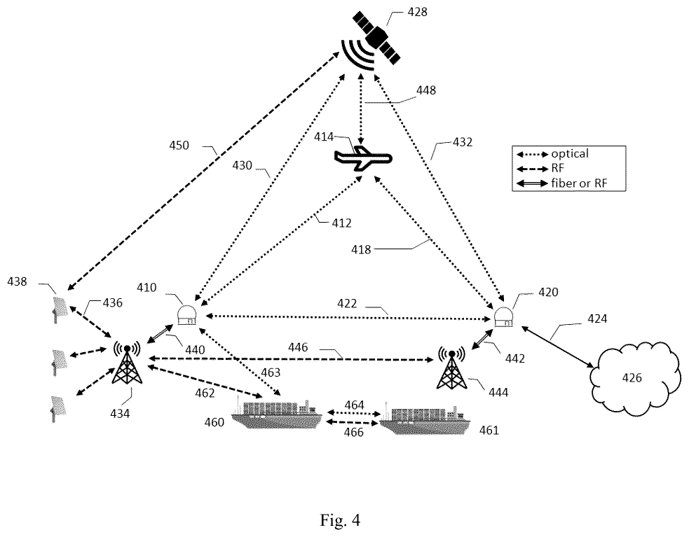

FIG. 4 describes how the invention can be used along with multiple system paths to distribute Extremely High Data Rate (EHDR) Internet connectivity and other communications services leveraging terrestrial point-to-point transmission. Access to the internet cloud 426 is obtained through a Terrestrial Optical Terminal (TOT) 420 that is located close to the Internet backbone and is therefore connected to the Internet through fiber 424. The TOT communicates point-to-point via line-of-sight optical link 422 to another TOT 410 that uses an RF or fiber link 440 to access a nearby or co-located microwave tower 434. The microwave tower then communicates via Radio Frequency (RF) signals 436 with broadband user terminals 438. Ship-to-shore and ship-to-ship communications are accommodated in this system, for example via direct optical links 463 between TOT 410 and ship 460 and direct optical link 464 between ships 460 and 461, with an alternative of using RF links 462 and/or 466 when atmospheric or distance conditions are not ideal for optical communications.

To overcome cloudy weather conditions, a High-Altitude Relay Platform (HARP) 414 can provide a first overlay relay method between the two TOTs via optical transmit and receive links 412 and 418. In addition, a satellite 428 can provide a second overlay relay method between the two TOTs via optical transmit and receive links 430 and 432. A third communications overlay approach would be to use another microwave tower 444 co-located and connected via an RF or fiber link 442 to the TOT 420 near the internet cloud 426 to receive from and transmit to the other microwave tower 434 via RF link 446. A fourth communication overlay approach would be to use the HARP 414 to relay between a remote TOT 410 and satellite 428 via optical link 418 and 448, respectively, to enable cloud-free network access for TOTs with cloud-impaired view of satellite 428. A fifth communication overlay approach would be to use satellite 428 to access a TOT 420 through an optical communications link 432 and then use a satellite RF communications link 450 to communicate with a user terminal 438. The various combinations, permutations, and variations of such overlay relay methods that can be configured as a function of the location of cloud impairment will be readily apparent to those skilled in the art.

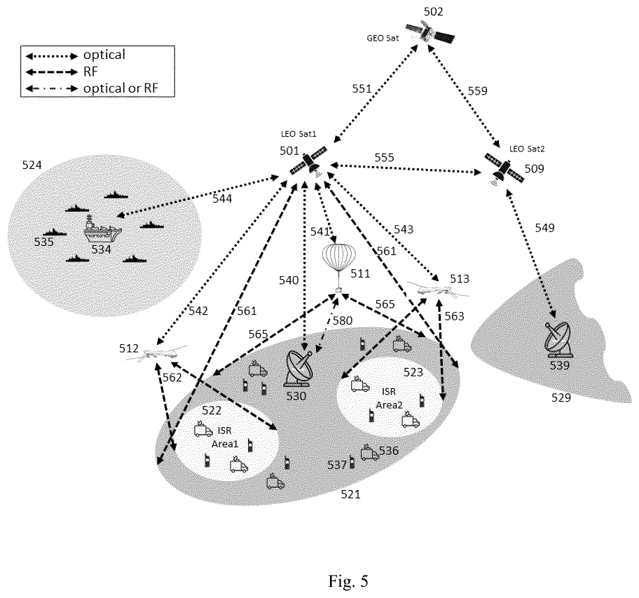

FIG. 5 illustrates an example of an application of the invention to defense strategic and tactical communications and observation and to civil Earth observation activities. For these applications, the benefits of the invention are high data capacity and high signal security, as well as low SWAP which facilitate use on satellites, airborne vehicles, and mobile assets. These benefits are particularly important in near real-time highly detailed imagery and remotely controlled operations. In this example, communications involve any or all of several space-based assets, several airborne assets, multiple ground-based assets, and multiple water-based assets including ocean-, sea-, and littoral-based assets.

The space-based Low Earth Orbit (LEO) satellites 501 and 509 and Geostationary Earth Orbit (GEO) satellite 502 communicate with each other via optical links to securely perform management (e.g., command & control) and high-capacity information aggregation and relay functions for the overall system. An ACN 511 provides close-in command, control & communications, and information support covering the entire theater of operations 521 via notionally-represented RF links 565. ACN 511 communicates via secure optical link 541 with a satellite 501 which can also communicate directly with a plurality of ground vehicles 536 and a plurality of personnel-borne personal communications devices 537 via theater-coverage RF links represented by 561. Satellite 501 can further communicate via secure optical link 540 with a ground-based gateway 530 which may be located inside or nearby outside the theater. Similarly, satellite 509 may communicate via secure optical link 549 with another ground-based gateway 539 inside or nearby outside another theater of operations 529. Gateway 530 may also maintain RF and/or optical links 580 with ACN 511 for path diversity and redundancy. Unmanned Aerial Vehicles (UAV) 512 and 513 each cover an Intelligence, Surveillance & Reconnaissance (ISR) and/or tactical operations area 522 and 523, respectively, and transmit high data rate information and imagery to satellite 501 and receive command, control, and communication from satellite 501 via secure optical links 542 and 543, respectively. UAVs 512 and 513 also transmit high data rate information and imagery within the ISR areas 522 and 523 via RF links 562 and 563 and may receive data from ground assets within their area of coverage. For water-based assets in their region of operations 524, a command or group lead vessel 534 communicates with satellite 501 via optical links 544 and supports other group member vessels 535. The above-enumerated free-space optical links configured in accordance with the invention provide exceptional communications and ISR data volumes with the high security enabled in large part by the narrow optical beam widths. The various combinations, permutations, and variations of the described communication paths that can be configured as a function of operational conditions will be readily apparent to those skilled in the art.

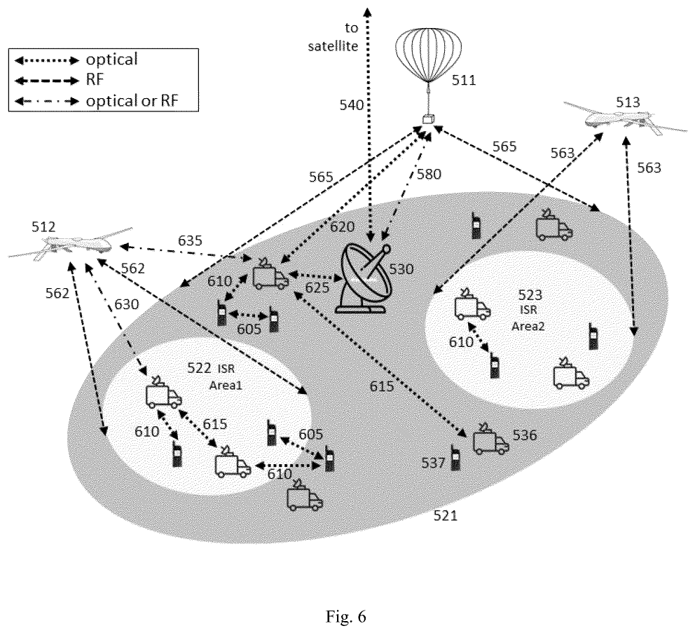

FIG. 6 illustrates the capabilities provided by the invention for mobile, transportable and portable optical terminals to provide and communicate events and situations in the form of real-time video and data in tactical operations as well as information and/or news gathering or entertainment programming where permanent optical terminal installation is not warranted, practical or cost-effective. For illustration, this is overlaid on the theater of operations 529 from FIG. 5 discussed above. The plurality of vehicles 536 and the plurality of portable personal communication devices 537 are understood to be equipped with or closely linked to a suitable optical terminal using the invention as an enabling SWAP factor to support mobile applications. Optical links 605 are operable between portable devices and personnel 537 to provide secure real-time awareness of events and situations and thereby allow them to be used and acted upon with immediacy to achieve desired objectives. Optical links 610 are operable between portable devices 537 and vehicles 536 to provide secure aggregation and relaying of events and situations to an ACN 511 and disseminate command and control information in the opposite direction. Optical links 615 are operable between multiple vehicles 536 to provide secure aggregation and relaying of events and situations in the field and/or to an ACN 511 and disseminate command and control information. Communication between vehicles 536 and ACN 511 is via optical link 620 although secure RF links may alternatively be used. Finally, if suitable line of sight is available, vehicles 536 may relay information via optical link 625 to gateway 530 for optical or RF transmission 580 to ACN 511 or optical transmission 540 directly to a satellite. Vehicles 536 that are in view of, for example, UAV 512 may perform the equivalent relay function via optical or RF link 635. The various combinations, permutations, and variations of the described communication paths that can be configured as a function of operational conditions will be readily apparent to those skilled in the art.

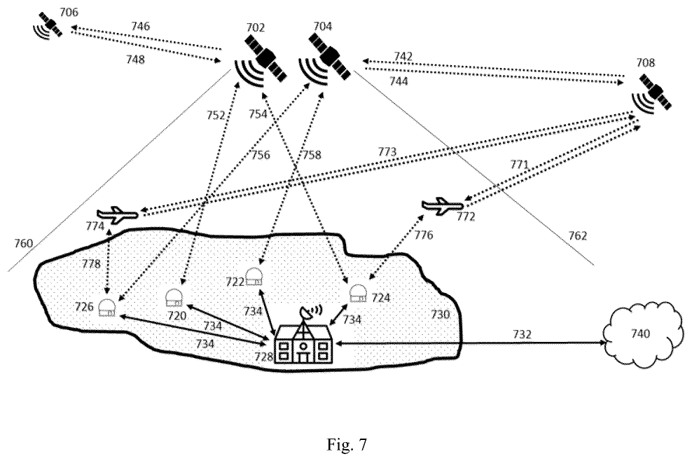

FIG. 7 illustrates the optical communications links between satellites that are part of a commercial communication constellation orbiting the Earth, and a gateway on the ground. Such a system may have hundreds of satellites in orbit and a number of gateways distributed over the Earth's surface. Satellites maintain RF user links and optical satellite-to-satellite and satellite-to-gateway links, and convert from RF to optical and optical to RF using the invention described herein. The optical gateway (OGW) operations region 730 on the ground includes the gateway processing facility 728, the fiber backbone 732 to the Internet cloud 740, and groups of optical terminal clusters (OTC) 720, 722, 724 and 726 connected to the processing building via optical fiber links 734. These OTCs each include many optical transmit and receive terminals that can each communicate with satellites that are within acceptable view, i.e., within the appropriate elevation angle 760 and 762 of the gateway region such that a communication link can be obtained. The number of optical terminal clusters will be equal to the maximum number of optical spatially isolated beams that may be transmitted and received from a single spacecraft. All optical terminals in the clusters support narrow-beamwidth, high-bandwidth receive and transmit beams for communication with satellites, and also transmit wide-beamwidth, limited-bandwidth optical beacon beams parallel to each communications beam to facilitate rapid satellite signal acquisition.

Optical transmit and receive beams 752, 754, 756, and 758 are shown going to and from satellites 702 and 704 from and to the optical terminal clusters 720, 722, 724 and 726. Each satellite has multiple optical terminals that can either link directly to the gateway or, as shown for example for satellites 706 and 708, indirectly via crosslink optical transmit and receive beams 742, 744, 746, and 748 through nearby satellites 702 and 704. An alternate optical path is provided by HARPs 772 and 774 in situations where the satellite is at a low elevation angle or when atmospheric conditions pose a risk to establishing or maintaining a direct optical link between a satellite and the gateway. For example, satellite 708 communicates optically with HARPs 772 and 774 via links 771 and 773, respectively, and the HARPs relay these optical signals to OTCs 724 and 726 via links 776 and 778.

In the above-described applications, a few links may require high free-space laser power due to distance or range to be covered, such as from one GEO satellite to another, and/or the need to traverse the entire atmosphere first in which case the atmospheric dispersion becomes a dominant factor, such as from the ground directly to a LEO satellite. In such cases the approach of using DLM of DFB lasers, combining the single-wavelength signals via WDM using an AWG, and amplification using an EDFA, may encounter device technology limitations in terms of power handling. For such links, the signal architecture can be mimicked at higher power using multiple DFBs with Electro Absorption Modulators (EAM) or Mach-Zehnder Modulator (MZM) to provide external modulation, with the output signals individually amplified by dedicated EDFAs, thus essentially using replication of hardware channels with current device technology to support the needed power levels. Alternative approaches include more exquisite beam steering technologies including adaptive optics and fast-steering mirrors.

Another link power mitigation method involves the apertures of the transmitting and receiving laser terminals. For example, for space-to-ground links, larger receiving terminals can be readily accommodated in ground installations, thus allowing the SWAP of the space hardware to remain low enough to be readily accommodated on the space vehicle. Similarly, this approach allows small terminals to be used on airborne assets where weight and size are at a premium, as well as in mobile applications where terminal portability and/or transportability are important factors. For any application of the invention, a trade-off assessment is expected to be performed between hardware power required, technology choices and terminal apertures to optimize the system to best meet performance, risk and cost objectives while considering the distance (range) of the communications link and the nature of the free-space medium, e.g., space or atmosphere.

For certain applications, such as a case where multiple diverse data streams must be flexibly routed to multiple diverse users, and/or where higher power levels per channel are desired, the incoming channels may be combined not by an AWG but by a Time Division Multiplexing (TDM) approach using, for example, an Optical Switch (OS), typically using Micro-Electro-Mechanical Systems (MEMS) technology to optically steer incoming beams, each for their allotted time interval, to the output fiber. The TDM output is then amplified by, for example, an EDFA, resulting in each channel receiving high amplification during its time interval. With appropriate signal modulation choices, this strategy can be fully compatible and interoperable with the invention as described in foregoing paragraphs, or it can operate as a standalone implementation.

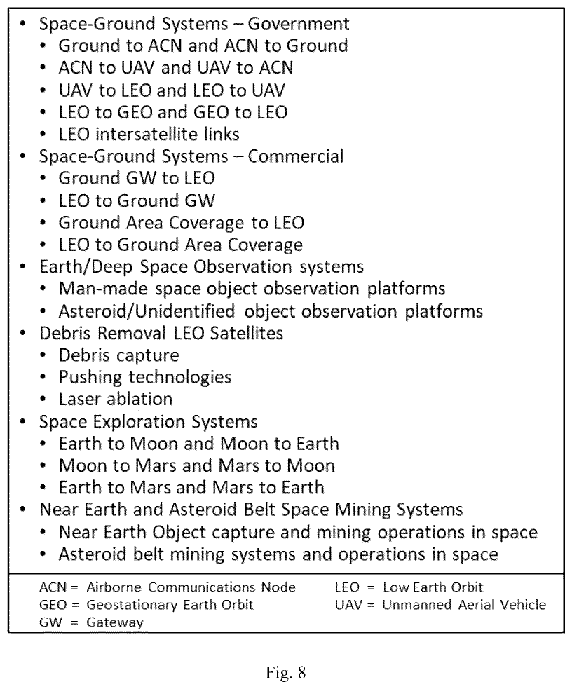

FIG. 8 summarizes applications in space which benefit from the high-bandwidth communications offered by the invention. These include applications requiring high volumes of real-time imagery for remote operations, such as in-orbit debris removal or asteroid mining, where real-time control and/or oversight from ground-based locations is a vital need.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for providing high-capacity communications using free-space optical links, the method comprising:
at a transmitting terminal, inserting a plurality N of parallel electrical signal streams carrying analog or digital data as the direct-modulating drive currents for an equal plurality N of lasers, each producing a modulated optical beam at a unique single wavelength;
combining the N optical beams of said plurality N of lasers into a single optical beam using Wavelength Division Multiplexing;
propagating said single optical beam through free space to a receiving terminal;
demultiplexing said single optical beam into its constituent N single-wavelength optical beams; and
detecting the data in each single-wavelength optical beam to recover the electrical signal streams carrying analog or digital data.

2. The method according to claim 1, wherein the method further comprises:
selecting the wavelengths for the N optical beams from within the laser communication C, L, and S bands.

3. The method according to claim 1, wherein the method further comprises:
selecting the apertures of the transmitting terminal and receiving terminal optical telescopes for said single optical beam to achieve desired power margins, reflecting accommodation constraints, link distance and free-space medium.

4. A method for providing high-capacity communications using free-space optical links, the method comprising:
at a transmitting terminal, inserting a plurality N of parallel electrical signal streams carrying analog or digital data as the direct-modulating drive currents for an equal plurality N of lasers commonly configured at a first polarization, each producing a modulated optical beam at a unique single wavelength;
combining the N optical beams of said plurality N of lasers into a first single optical beam using Wavelength Division Multiplexing;
inserting a plurality M of parallel electrical signal streams carrying analog or digital data as the direct-modulating drive currents for an equal plurality M of lasers commonly configured at a second polarization being the opposite of said first polarization, each producing a modulated optical beam at a unique single wavelength;
combining the M optical beams of said plurality M of lasers into a second single optical beam using Wavelength Division Multiplexing;
combining said first and second single optical beams in to a combined optical beam;
propagating said combined optical beam through free space to a receiving terminal;
separating said combined optical beam into two single received optical beams at said first and second polarizations;
demultiplexing said single received optical beams into their constituent single-wavelength optical beams; and
detecting the data in each single-wavelength optical beam to recover the electrical signal streams carrying analog or digital data.

5. The method according to claim 4, wherein the quantities N and M are equal.

6. A system for point-to-point optical communication, the system comprising:
a transmitting terminal and a receiving terminal, wherein the transmitting terminal is configured to communicate with the receiving terminal through optical laser links propagated through free space, and wherein the optical beams are generated by direct modulation of distributed-feedback (DFB) lasers.

7. The system according to claim 6, wherein the transmitting terminal includes or is collocated with a receiving terminal.

8. The system according to claim 6, wherein the receiving terminal includes or is collocated with a transmitting terminal.

9. The system according to claim 6, wherein the drive currents of a plurality N of said DFB lasers are modulated by an equal plurality N of parallel electrical signal streams carrying analog or digital data and are configured to generate N optical beams with unique single wavelengths, which further are multiplexed into a single optical beam using one or more Arrayed Waveguide Gratings (AWG), following which said single optical beam is amplified and transmitted.

10. The system according to claim 9, wherein said receiving terminal receives and amplifies said single optical beam which further is demultiplexed into N single-wavelength optical beams using one or more AWGs.

11. The system according to claim 6, wherein the system further comprises one or more relay nodes, the one or more relay nodes being configured to relay the single optical beam laser links.

12. The system according to claim 6, wherein the transmitting terminal is configured to operate on, and is located on land, a mobile vehicle, a person, a ship, an airborne high-altitude platform or drone, or an orbiting spacecraft.

13. The system according to claim 6, wherein the receiving terminal is configured to operate on, and is located on land, a mobile vehicle, a person, a ship, an airborne high-altitude platform or drone, or an orbiting spacecraft.

14. The system according to claim 11, wherein the one or more relay nodes are configured to operate on, and are located on land, a mobile vehicle, a person, a ship, an airborne high-altitude platform or drone, or an orbiting spacecraft.

15. The system according to claim 6, wherein the system is interoperable with terminals configured to generate compatible optical communication beam modulations and multiplexing schemes using alternate hardware configurations.
